(19) United States
(12) Patent Application Publication
(10) Pub. No.: US 2018/0118342 A1
(43) Pub. Date: May 3, 2018

(54) TABLE INCLUDING A DISPLAY

(71) Applicant: Gulfstream Aerospace Corporation, Savannah, GA (US)

(72) Inventor: Aram Kasparian, Savannah, GA (US)

(21) Appl. No.: 15/339,736

(22) Filed: Oct. 31, 2016

(51) Int. Cl. B64D 11/00; A47B 1/10; A47B 5/00; A47B 37/00; B60N 3/00; B60R 11/02

(52) U.S. Cl. CPC B64D 11/0015; A47B 1/10; A47B 5/00; A47B 2200/008; B60N 3/001; B60R 11/0235; B64D 11/00; A47B 37/00

(57) ABSTRACT

A table is provided including a display. The table includes a base section having a first base section end and a second base section end. The base section extends along a first axis. The table further includes a joint section having a curved shape and disposed adjacent the second base section end. The table also includes a display section including the display. The display section has a first display section end and a second display section end. The display section extends along a second axis with the first display section end disposed adjacent the joint section. The first axis and the second axis are transverse to each other. An aircraft is also provided including the table. The aircraft includes a fuselage defining an interior and including a window. The table is disposed within the interior and adjacent the window.

### TECHNICAL FIELD

The present invention generally relates to a table and more particularly relates to a table including a display.

### BACKGROUND

An aircraft may include one or more tables within its cabin for use by occupants of the aircraft. Often, these tables are adjacent windows, or other visually desirable object or areas, for esthetic purposes. Occupants may operate electronic devices, such as tablets, computers, and television displays, while using the table. With the increasing usage of these electronic devices during flight, placement of these devices in a secure, accessible, and esthetically pleasing location is challenging.

One conventional option includes placing the device on the table. However, the device must be securely fastened to the table to prevent unintentional shifting during flight. Depending on the manner by which the device is fastened to the table, the device may reduce the working space of the table, limit a view of adjacent windows or other visually desirable objects or areas or limit accessibility of the device. As one example, if a display is placed in the center of the table, the working space of the table is reduced by the footprint of the display, the display will limit the view of windows, objects, areas, or other occupants located on the other side of the display, and the occupants located on the other side of the display will be unable to view and interact with information displayed on the display. As another example, if a display is embedded into the surface of the table, the working space of the table is reduced when an occupant desires to use the table and operate the device at the same time, and only the occupants located adjacent the table will be able to view and interact with information displayed on the display. As another example, if a display is placed at an edge of the table, it may limit the view of windows, objects, areas, or other occupants located on the other side of the display.

Another conventional option includes securing the device to a retractable mount that can be visible when being operated and retracted into the table when not being operated. In addition to the challenges identified above regarding placing the device on the table, the retractable mount is a complex apparatus requiring significant space that can limit the esthetics of the table.

Accordingly, it is desirable to provide an improved table. Furthermore, other desirable features and characteristics will become apparent from the subsequent summary and detailed description and the appended claims, taken in conjunction with the accompanying drawings and the foregoing technical field and background.

### BRIEF SUMMARY

Various non-limiting embodiments of a table including a display and various non-limiting embodiments of an aircraft including the table, are disclosed herein.

In one non-limiting embodiment, the table includes, but is not limited to, a base section having a first base section end and a second base section end spaced from the first base section end. The base section extends along a first axis between the first base section end and the second base section end. The table further includes, but is not limited to, a joint section having a curved shape and disposed adjacent the second base section end. The table also includes, but is not limited to, a display section including a display. The display section has a first display section end and a second display section end spaced from the first display section end. The display section extends along a second axis between the first display section end and the second display section end with the first display section end disposed adjacent the joint section. The first axis and the second axis are transverse to each other.

In another non-limiting embodiment, the aircraft includes, but is not limited to, a fuselage defining an interior and including a window. The table is disposed within the interior and adjacent the window.

### BRIEF DESCRIPTION OF THE DRAWINGS

The present invention will hereinafter be described in conjunction with the following drawing figures, wherein like numerals denote like elements, and

FIG. 1 is a perspective view illustrating a non-limiting embodiment of a table including a display; and

FIG. 2 is a perspective view illustrating a non-limiting embodiment of an aircraft including the table of FIG. 1.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

A table including a display is provided herein. In an exemplary embodiment, the table includes a base section, a joint section, and a display section with the joint section disposed between the base section and the display section. The joint section has a curved shaped such that the display section extends perpendicular to the base section thereby placing the display section in a viewing position for users of the table. The base section, the joint section, and the display section cooperate to form a cross section having a generally L-shape such that the display section appears to be a contiguous extension of the base section. The display section includes the display, which is transparent, thereby permitting windows, objects, areas, or other users located on the opposite side of the display to be visible to users of the display.

An aircraft is also taught herein. In another exemplary embodiment, the aircraft includes a fuselage defining an interior and including a window. The table is disposed within the interior with the display section, which is transparent, disposed adjacent the window. Daylight entering the interior of the aircraft through the window may pass through the display section when the display section such that the amount of daylight entering the interior is maximized.

A greater understanding of the table described above may be obtained through a review of the illustrations accompanying this application together with a review of the detailed description that follows.

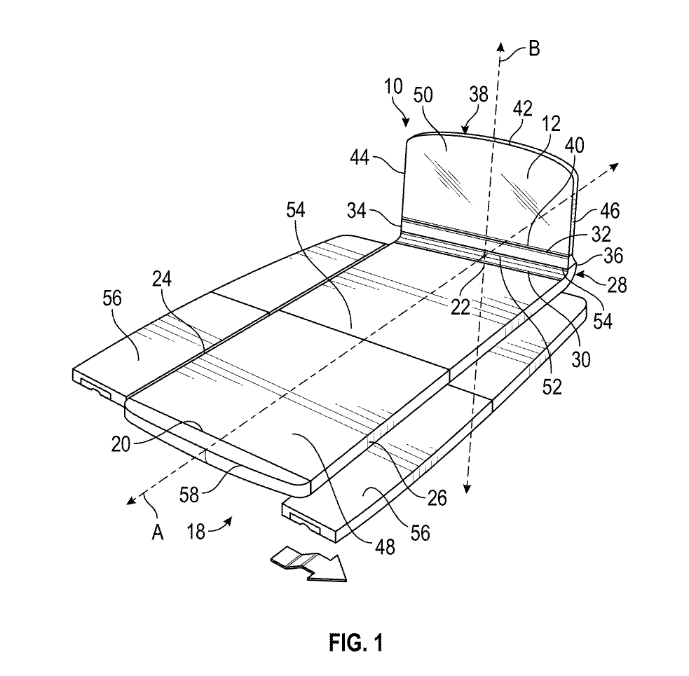

FIG. 1 is a perspective view illustrating a non-limiting embodiment of a table 10 including a display 12. Although the context of the present discussion teaches the use of the subject table onboard an aircraft, it should be understood that the table taught herein is not limited to use onboard an aircraft. Rather, the table described and claimed herein may have applications in other vehicles including, but not limited to, ground based vehicles such as, but not limited to, vans, minivans, buses, other types of automobiles, and rail-based ground vehicles. Additionally, the table described and claimed herein may also be used onboard watercraft and spacecraft. In still other embodiments, the table taught herein is not limited to use with vehicles and may be employed in any setting including residential applications, office applications, and commercial applications.

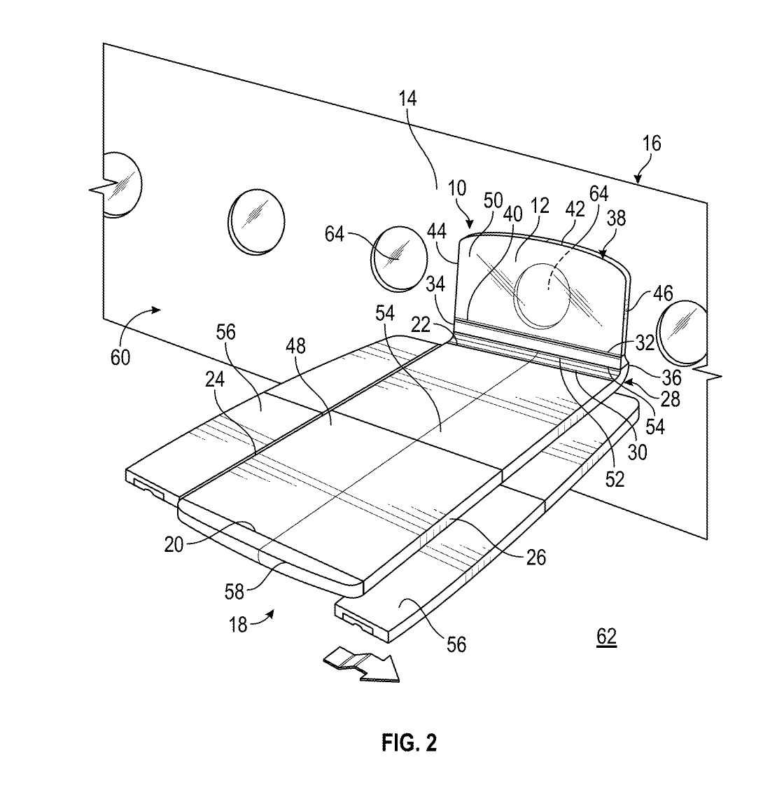

In embodiments, the table 10 is in an elevated position and configured to be utilized by one or more users for a variety of activities, such as conversing, reading, writing, observing, eating, or the like. In certain embodiments, the table 10 may be supported by one or more support members (not shown) to maintain the table 10 in the elevated position. In other embodiments, the table 10 is coupled to a structural member 14 (see FIG. 2), such as a wall panel of an aircraft 16 (see FIG. 2), to maintain the table 10 in the elevated position.

The table 10 includes a base section 18. The base section 18 may be any suitable shape such as circular, ovular, rectangular, or any other multisided polygon. The base section 18 has a first base section end 20 and a second base section end 22 spaced from the first base section end 20. In embodiments when the base section 18 has a rectangular shape, one side of the rectangular shape is the first base section end 20 and the opposite side of the rectangular shape is the second base section end 22. In embodiments wherein the base section 18 has a shape without discrete sides about its circumference, such as a circular shape or an ovular shape, a portion of the circumference of the shape is the first base section end 20 and another portion of the circumference of the shape is the second base section end 22. The base section 18 extends along a first axis A between the first base section end 20 and the second base section end 22.

In embodiments, the base section 18 has a first base section side 24 and a second base section side 26 spaced from the first base section side 24. The first base section end 20 may have a first base section end width, which extends between the first base section side 24 and a second base section side 26, in an amount of from 5 to 100, alternatively from 5 to 50, or alternatively from 10 to 20, inches. The second base section end 22 may have a second base section end width, which extends between the first base section side 24 and the second base section side 26, in an amount of from 5 to 100, alternatively from 5 to 50, or alternatively from 10 to 20, inches.

The table 10 further includes a joint section 28 having a curved shape and disposed adjacent the second base section end 22. In embodiments, the joint section 28 has a first joint section end 30 and a second joint section end 32 spaced from the first joint section end 30 with the curved shape of the joint section 28 extending between the first joint section end 30 and the second joint section end 32. The first joint section end 30 may be abutting the second base section end 22. In these embodiments, it is to be appreciated that the joint section 28 may include a variety of configurations so long as the joint section 28 has the curved shape extending between the first joint section end 30 and the second joint section end 32. For example, as shown in FIG. 1, the joint section 28 tappers inward proximate the second joint section end 32. In certain embodiments, the curved shape of the joint section 28 is a concave shape extending between the first joint section end 30 and the second joint section end 32. In various embodiments, the joint section 28 has a cross section extending between the first joint section end 30 and the second joint section end 32 with the cross section of the joint section 28 having a concave shape. In embodiments, the joint section 28 has a first joint section side 34 and a second joint section side 36 spaced from the first joint section side 34. The first joint section side 34 extending between the first joint section end 30 and the second joint section end 32 may curve at an angle of from 45 to 135, alternatively 70 to 110, or alternatively 80 to 100, degrees. The second joint section side 36 extending between the first joint section end 30 and the second joint section end 32 may curve at an angle of from 45 to 135, alternatively 70 to 110, or alternatively 80 to 100, degrees. In one embodiment, the first joint section side 34 and the second joint section side 36 curve at an angle of 90 degrees. The first joint section end 30 may have a first joint section end width, which extends between the first joint section side 34 and a second joint section side 36, in an amount of from 5 to 100, alternatively from 5 to 50, or alternatively from 10 to 20, inches. The second joint section end 32 may have a second joint section end width, which extends between the first joint section side 34 and a second joint section side 36, in an amount of from 5 to 100, alternatively from 5 to 50, or alternatively from 10 to 20, inches.

In embodiments, the curved shape of the joint section 28 may be adjustable. In particular, the second joint section end 32 may be movable between a first joint section position and a second joint section position by adjusting the angle of the curve of the first joint section side 34 and the second joint section side 36 in an amount of from −80 to +80, alternatively from −45 to +45, or alternatively from −15 to +15, degrees. It is to be appreciated that the second joint section end 32 may be moveable to any number of positions between the first joint section position and the second joint section position.

The table 10 further includes a display section 38. The display section 38 may be any suitable shape such as circular, ovular, rectangular, or any other multisided polygon. The display section 38 has a first display section end 40 and a second display section end 42 spaced from the first display section end 40. The first display section end 40 is disposed adjacent the joint section 28 such that the display section 38 is proximate the second base section end 22. The first display section end 40 may be abutting the second joint section end 32. In embodiments, the display section 38 is coupled to the joint section 28 such that the display section 38 is coupled to the table 10 to prevent unintentional movement or shifting of the display section 38. The display section 38 extends along a second axis B between the first display section end 40 and the second display section end 42 with the first axis A and the second axis B transverse to each other. In certain embodiments, the first axis A and the second axis B are perpendicular to each other. It is to be appreciated that because the joint section 28 curves and the display section 38 is adjacent the joint section 28, exposure of the display section 38 to food, drinks, or other items placed on the base section 18 is minimized.

As a result of the display section 38 being proximate the second base section end 22, and the first axis A and the second axis B being transverse to each other, the base section 18, the display section 38, and the joint section 28 may cooperate to form a cross section of the table 10 having a generally L-shape such that the display section 38 may appear to be a contiguous extension of the base section 18. The terminology “generally,” as utilized herein with regard to the L-shape of the table 10, means that the cross section of the table 10 is configured to closely resemble the letter “L” but may include additional features such as curves, ridges, etc. that are not typically associated with the letter “L.” It is to be appreciated that when the base section 18, the display section 38, and the joint section 28 cooperate to form a cross section having the generally L-shape, the placement of the display section 38 proximate the second base section end 22 maximizes the working space of the table 10 and maximizes accessibility of the display 12 to users surrounding and spaced from the table 10.

In embodiments, the display section 38 is transparent. The terminology “transparent,” as utilized herein with regard to the display section 38, mean that visible light can pass through the display section 38 in an amount of at least 10%, alternatively at least 25%, alternatively at least 50%, alternatively at least 75%, or alternatively at least 90%. It is to be appreciated that when the display section 38 is transparent, windows, objects, areas, or other users located on the opposite side of the display 12 are visible to users of the display 12. In certain embodiments, the display section 38 is configured to disengage from the joint section 28 under a predetermined force that may be applied to the display section 38. This configuration may also be referred to as a “break-away” feature. In various embodiments, disengagement of the display section 38 from the joint section 28 may occur when the predetermined force is equivalent to a force that may be applied by an average person.

In embodiments, the display section 38 has a first display section side 44 and a second display section side 46 spaced from the first display section side 44. The first display section end 40 may have a first display section end width, which extends between the first display section side 44 and a second display section side 46, in an amount of from 5 to 100, alternatively from 5 to 50, or alternatively from 10 to 20, inches. The second display section end 42 may have a second display section end width, which extends between the first display section side 44 and a second display section side 46, in an amount of from 5 to 100, alternatively from 5 to 50, or alternatively from 10 to 20, inches. In certain embodiments, the second base section end width and the first display section end width are in a ratio of from 1:0.8 to 1:1.2. In one embodiment, the second base section end width and the first display section end width are the same. It is to be appreciated that when the second base section end width and the first display section end width are in the ratio of from 1:0.8 to 1:1.2, the display section 38 may appear to be a contiguous extension of the base section 18 thereby improving the esthetic appearance of the table 10 while still maximizing the workspace of the table 10 and the accessibility of the display 12 to users surrounding and spaced from the table 10. In another embodiment, the second base section end width, the first joint section end width, the second joint section end width, and the first display section end width are the same. In embodiments, the display section 38 has a height extending between the first display section end 40 and the second display section end 42 in an amount of from 5 to 50, alternatively from 5 to 25, or alternatively from 10 to 20, inches.

The display section 38 includes the display 12. The display 12 may be any suitable type of display such as an organic light-emitting diode (OLED) display, a light-emitting diode (LED) display, a liquid crystal display (LCD), a plasma display, or a holographic display. In various embodiments, the display 12 is an OLED display. The display 12 may utilize a variety of input devices such as touchscreen input, a stylus, a touchpad, a mouse, a microphone, a camera, and the like. In certain embodiments, the display 12 and the display section 38 are the same component. In other embodiments, the display 12 and the display section 38 are separate components with the display 12 disposed in the display section 38. The display 12 may extend between the first display section end 40 and the second display section end 42. The display 12 may extend between the first display section side 44 and the second display section side 46. In embodiments, when the display section 38 is transparent, the display 12 is also transparent such that windows, objects, areas, or other occupants located on the opposite side of the display 12 are visible to users of the table 10 and/or the display 12. It is to be appreciated that when the display is being operated, visibility of windows, objects, areas, or other occupants located on the opposite side of the display 12 may be reduced.

In embodiments, the base section 18 includes a base section face 48 and the display section 38 includes a display section face 50. The base section face 48 and the display section face 50 are substantially flat to form the table 10 having a contiguous surface from the first base section end 20 to the second joint section end 32. The terminology “substantially,” as utilized herein with regard to the base section face 48 and the display section face 50 being flat means that the base section face 48 and the display section face 50 may include features such as ridges, divots, seams, etc. so long as these features only minimally impact the flat characteristics of the base section face 48 and the display section face 50.

In embodiments, the joint section 28 includes a joint section face 52. In certain embodiments, the table 10 further includes a surface layer 54 disposed on the base section face 48 and the joint section face 52, and extending from the first base section end 20 to the second joint section end 32. It is to be appreciated that when the surface layer 54 is disposed on the base section face 48 and the joint section face 52, the display section 38 may appear to be a contiguous extension of the base section 18 thereby improving the esthetic appearance of the table 10.

The table 10 may include at least one table leaf 56. The table leaf 56 may be coupled to base section 18. In embodiments, the table leaf 56 is disposed adjacent at least one of the first base section side 24 and the second base section side 26. In embodiments, the table leaf 56 extends along the base section 18 between the first base section end 20 and the second base section end 22. The table 10 including the at least one table leaf 56 may have increased capacity for users of the table 10 as compared to a table not including the at least one table leaf 56. In embodiments, the table leaf 56 has a width in an amount of from 2 to 50, alternatively from 5 to 25, or alternatively from 5 to 15, inches.

The table 10 may include an end cap 58. The end cap 58 may be coupled to the base section 18. In embodiments, the end cap 58 is disposed adjacent the first base section end 20. In embodiments, the end cap 58 extends along the base section 18 between the first base section side 24 and the second base section side 26. The table 10 including the end cap 58 may have improved esthetic appearance as compared to a table not including the end cap 58.

FIG. 2 is a perspective view illustrating a non-limiting embodiment of the aircraft 16 including the table 10 of FIG. 1. The aircraft 16 includes a fuselage 60 defining an interior 62. The fuselage 60 includes a window 64. In embodiments, the window 64 is disposed within the structural member 14 of the aircraft 16. The table 10 is disposed within the interior 62 and is adjacent the window 64. In certain embodiments, the display section 38 is disposed adjacent the window 64 and the display section 38 is transparent. As described above, the table 10 may be coupled to the structural member 14 to maintain the table 10 in the elevated position. It is to be appreciated that daylight entering the interior 62 of the aircraft 16 through the window 64 may pass through the display section 38 when the display section 38 is transparent such that the amount of daylight entering the interior 62 is maximized as compared to a display section of a table that is not transparent.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A table including a display, comprising:
a base section having a first base section end and a second base section end spaced from the first base section end, and extending along a first axis between the first base section end and the second base section end;
a joint section having a curved shape and disposed adjacent the second base section end; and
a display section comprising the display, having a first display section end and a second display section end spaced from the first display section end, and extending along a second axis between the first display section end and the second display section end with the first display section end disposed adjacent the joint section;
wherein the first axis and the second axis are transverse to each other.

2. The table according to claim 1, wherein the display section is transparent.

3. The table according to claim 1, wherein the display is an organic light-emitting diode (OLED) display.

4. The table according to claim 1, wherein the joint section has a first joint section end and a second joint section end spaced from the first joint section end, the first joint section end is abutting the second base section end, and the second joint section end is abutting the first display section end.

5. The table according to claim 4, wherein the joint section has a cross section extending between the first joint section end and the second joint section end, and the cross section of the joint section has a concave shape.

6. The table according to claim 1, wherein the second base section end has a second base section end width and the first display section end has a first display section end width, and the second base section end width and the first display section end width are in a ratio of from 1:0.8 to 1:1.2.

7. The table according to claim 1, wherein the first axis and the second axis are perpendicular to each other.

8. The table according to claim 1, wherein the base section comprises a base section face and the display section comprises a display section face, and the base section face and the display section face are substantially flat to form the table having a contiguous surface from the first base section end to the second joint section end.

9. The table according to claim 1, wherein the base section comprises a base section face and the joint section comprises a joint section face, and the table further comprises a surface layer disposed on the base section face and the joint section face which extends from the first base section end to the second joint section end.

10. The table according to claim 1, wherein the base section, the display section, and the joint section cooperate to form a cross section of the table having a generally L-shape.

11. An aircraft, comprising:
a fuselage defining an interior and comprising a window;
a table disposed within the interior and adjacent the window, the table comprising;
a base section having a first base section end and a second base section end spaced from the first base section end, and extending along a first axis between the first base section end and the second base section end;
a joint section having a curved shape and disposed adjacent the second base section end; and
a display section comprising the display, having a first display section end and a second display section end spaced from the first display section end, and extending along a second axis between the first display section end and the second display section end with the first display section end disposed adjacent the joint section;
wherein the first axis and the second axis are transverse to each other.

12. The aircraft according to claim 11, wherein the display section is disposed adjacent the window.

13. The aircraft according to claim 11, wherein the display section is transparent.

14. The aircraft according to claim 11, wherein the display is an organic light-emitting diode (OLED) display.

15. The aircraft according to claim 11, wherein the joint section has a first joint section end and a second joint section end spaced from the first joint section end, the first joint section end is abutting the second base section end, and the second joint section end is abutting the first display section end.

16. The aircraft according to claim 15, wherein the joint section has a cross section extending between the first joint section end and the second joint section end, and the cross section of the joint section has a concave shape.

17. The aircraft according to claim 11, wherein the second base section end has a second base section end width and the first display section end has a first display section end width, and the second base section end width and the first display section end width are in a ratio of from 1:0.8 to 1:1.2.

18. The aircraft according to claim 11, wherein the first axis and the second axis are perpendicular to each other.

19. The aircraft according to claim 11, wherein the base section comprises a base section face and the display section comprises a display section face, and the base section face and the display section face are substantially flat to form the table having a contiguous surface from the first base section end to the second joint section end.

20. The aircraft according to claim 11, wherein the base section comprises a base section face and the joint section comprises a joint section face, and the table further comprises a surface layer disposed on the base section face and the joint section face which extends from the first base section end to the second joint section end.
